(19) United States
(12) Patent Application Publication
(10) Pub. No.: US 2020/0346602 A1
(43) Pub. Date: Nov. 5, 2020

(54) SYSTEM FOR DETECTING OCCUPANT OF VEHICLE AND SYSTEM FOR CONTROLLING ILLUMINATION INSIDE VEHICLE

(71) Applicant: DENSO CORPORATION, Kariya-city (JP)

(72) Inventor: Kensuke YOKOI, Kariya-city (JP)

(21) Appl. No.: 16/931,340

(22) Filed: Jul. 16, 2020

Related U.S. Application Data
(63) Continuation of application No. PCT/JP2019/001224, filed on Jan. 17, 2019.

(30) Foreign Application Priority Data
Jan. 18, 2018 (JP) 2018-006362

(51) Int. Cl. B60R 21/015; B60Q 3/80; H05B 47/105

(52) U.S. Cl. CPC B60R 21/01516; H05B 47/105; B60Q 3/80

(57) ABSTRACT

In an occupant detection system for detecting an occupant of a vehicle, an imaging unit captures an image of an interior of the vehicle and a lighting unit illuminates a region in a field of view of the imaging unit. A lighting control unit automatically controls the lighting unit so that an integrated amount of light of the lighting unit changes. An occupant detection unit detects an occupant based on the image captured by the imaging unit.

### CROSS REFERENCE TO RELATED APPLICATIONS

This application is based on Japanese Application No. 2018-6362 filed on Jan. 18, 2018, the contents of which are incorporated herein by reference.

### BACKGROUND

### Technical Field

The present disclosure relates to a system for detecting an occupant of a vehicle, and a system for controlling the illumination inside the vehicle.

### Related Art

Conventionally, a technique is known which detects an occupant based on a captured image obtained by capturing an image of the inside of the vehicle or a detected value of a load sensor provided in the seat.

### BRIEF DESCRIPTION OF THE DRAWINGS

In the accompanying drawings:

FIG. 1 is a diagram illustrating a vehicle according to the first embodiment of the present disclosure;

FIG. 2 is a diagram illustrating an example of how the camera is mounted according to the first embodiment of the present disclosure;

FIG. 3 is a diagram illustrating an example of an image captured by the camera according to the first embodiment of the present disclosure;

FIG. 4 is a block diagram illustrating the configuration of the vehicle according to the first embodiment of the present disclosure;

FIG. 5 is a flowchart of the process executed in the occupant detection system and the lighting control system according to the first embodiment of the present disclosure;

FIG. 6 is a block diagram illustrating the configuration of a vehicle according to the second embodiment of the present disclosure; and

FIG. 7 is a block diagram illustrating the configuration of a vehicle according to the third embodiment of the present disclosure.

### DESCRIPTION OF SPECIFIC EMBODIMENTS

JP-A-2013-252863 discloses a technique of determining whether an occupant or a child seat is present on a seat based on a captured image to appropriately control the pretensioner of the seat belt or the airbag. JP-A-2016-203910 discloses a technique of accurately detecting the position of the occupant based on a captured image obtained by capturing an image of the inside of the vehicle.

However, in the case where the occupant is detected based on a captured image obtained by capturing an image of the inside of the vehicle, when the inside of the vehicle is dark, the overall brightness of the captured image becomes low and the image may have a reduced contrast, which may make occupant detection impossible even by image recognition.

On the other hand, it is inconvenient to install a light source in the vehicle and operate the light source manually by an occupant to adjust the amount of light for occupant detection by image recognition, and also, for the prevention of leaving children or elderly people in the vehicle, the amount of light needs to be controlled in a situation where there is no occupant to operate it. If the interior of the vehicle is constantly illuminated at night or in other situations where the interior of the vehicle is dark, the occupants may feel uncomfortable and also the pupils of the driver may close, making it difficult for the driver to grasp the situation outside the vehicle.

In view of the foregoing, it is desired to have a technique for controlling the lighting inside the vehicle to facilitate occupant detection.

Embodiments of the present disclosure will be described in the following referring to the drawings. In each of the following embodiments, components that are the same or equivalent in respective embodiments are described using identical reference labels.

In the following, embodiments of the present disclosure will be described in more detail with reference to the appended drawings. However, the present disclosure may be embodied in many different forms, and it should not be construed that the present disclosure is limited to the embodiments set forth herein. These embodiments are rather provided to make the disclosure thorough and complete, and to fully convey the scope of the disclosure to those skilled in the art. Note that similar reference signs denote similar components throughout the drawings.

### First Embodiment

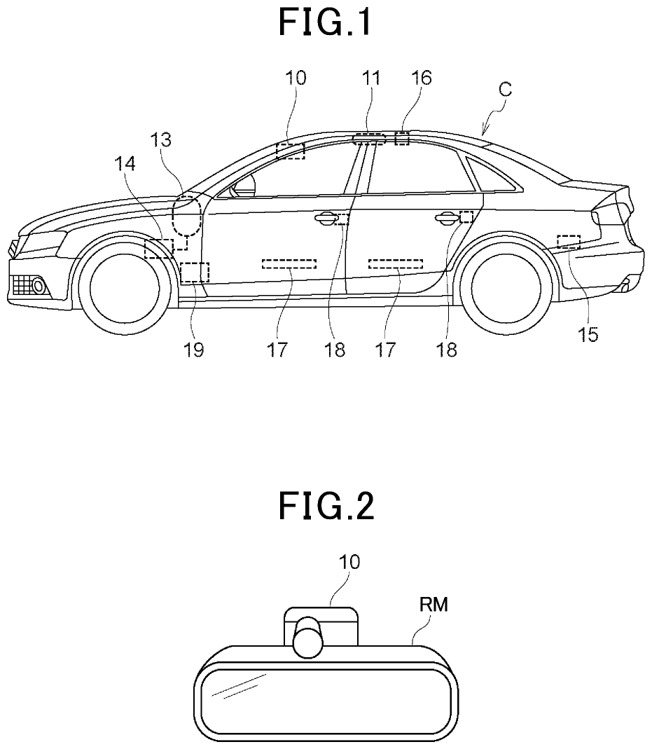

FIG. 1 is a diagram illustrating a vehicle according to a first embodiment of the present disclosure. The vehicle C comprises a camera 10 attached above the rear-view mirror and facing rearward to capture an image of the inside of the vehicle C. The camera 10 has a relatively wide field of view so that it can capture not only the rear seat but also the driver's seat and the passenger seat. In addition, an interior light 11 is installed on the ceiling of the passenger compartment of the vehicle C as a lighting unit or a light source. The interior light 11 illuminates at least a part of the field of view of the camera 10. The camera 10 corresponds to an imaging unit for capturing an image of the inside of the vehicle.

An airbag 13 is provided in the part of the dashboard in front of the passenger seat. Although not shown in the drawing, airbags are also provided in the steering wheel of the driver's seat and in the parts above the door windows. The airbags 13 are controlled by an airbag ECU 14. More specifically, when collision is detected by a collision detection sensor (not shown), the airbag ECU 14 sends an ignition instruction to the inflator of each airbag 13 according to the settings for each airbag 13, and thereby inflates the airbags 13. The airbag ECU 14 can be configured so that the strength of the explosion of the inflator, that is, the strength of the inflation of the airbag 13 can be set, which makes it possible to set the strength as appropriate, for example, set the strength low for children. The airbag ECU 14 corresponds to an airbag control unit for controlling the airbags.

The vehicle C is further provided with a buzzer 15 as an alarm unit that emits an alarm sound. Although the arrangement of the buzzer 15 is not particularly limited, the buzzer 15 is installed in the vehicle C so that the alarm sound can be heard even from outside the vehicle C.

An illuminance sensor 16 is provided inside the vehicle C for detecting the ambient light in the passenger compartment, that is, the brightness in the passenger compartment. The illuminance sensor 16 detects the brightness of a region including at least a part of the field of view of the camera 10, for example, the part corresponding to the head of an occupant in a rear seat. Further, under each of the driver's seat, the passenger seat, the right rear seat, the left rear seat, and the center rear seat, a load sensor 17 for detecting the load applied to each seat is provided. Furthermore, a door open/close sensor 18 for detecting opening/closing of each door is provided at the driver's seat door, the passenger seat door, and the left and right rear seat doors. The door open/close sensor 18 can detect opening and closing of the door. A control device 19 is provided at an appropriate position in the vehicle C. The illuminance sensor 16 corresponds to a measuring unit for measuring ambient light. The door open/close sensor 18 corresponds to a door detection unit for detecting opening/closing of a vehicle door.

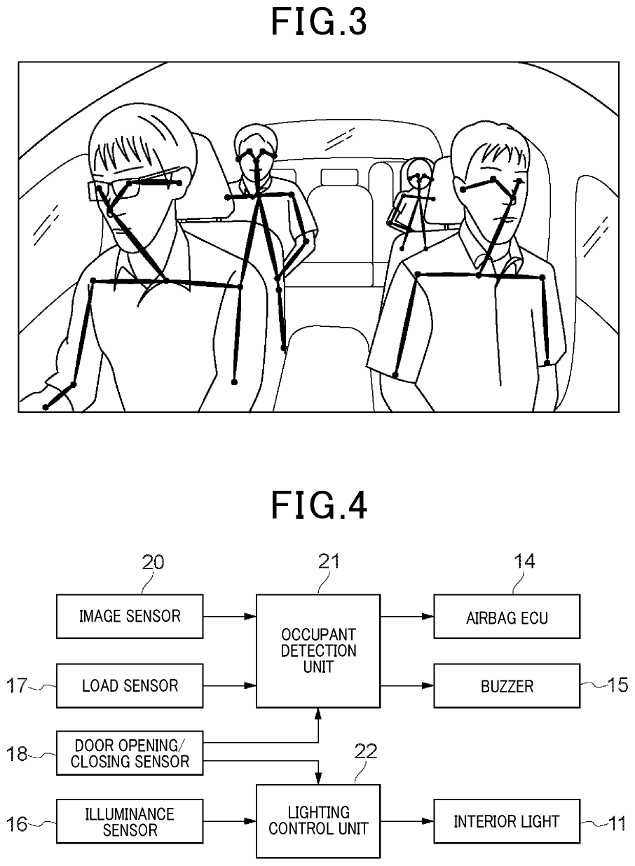

FIG. 2 is a diagram illustrating an example of the attachment of the camera according to the first embodiment of the present disclosure, and FIG. 3 is an example of an image obtained by the camera according to the first embodiment of the present disclosure. As shown in FIG. 2, the camera 10 is fixed to the rear-view mirror RM, and the lens is located above the rear-view mirror RM. With such positioning of the camera 10, the driver's seat, the passenger seat, and the rear seats can be captured in the image as shown in FIG. 3 without obstructing the driver's view. FIG. 3 also shows the result of the image recognition, which will be described later.

FIG. 4 is a block diagram illustrating the configuration of the vehicle according to the first embodiment of the present disclosure. FIG. 4 shows the configuration for occupant detection and lighting control in the vehicle C, and the configuration of FIG. 4 forms an occupant detection system or a lighting control system of the vehicle C. The vehicle C comprises an image sensor 20 provided in the camera 10, load sensors 17, door open/close sensors 18, an illuminance sensor 16, an occupant detection unit 21 and a lighting control unit 22 realized by a control device 19, an airbag ECU 14, a buzzer 15, and an interior light 11.

The image sensor 20 captures and image at predetermined time intervals to generate captured images, and outputs the captured images to the occupant detection unit 21. The occupant detection unit 21 performs image recognition on the captured image obtained by the image sensor 10 when the door open/close sensor 18 detects that the door has been closed. More specifically, the occupant detection unit 21 performs image recognition on the image obtained by the image sensor 20 to recognize a human and a child seat for each of the driver's seat, the passenger seat, the right rear seat, the left rear seat, and the center rear seat. For example, this recognition may be performed using an object detection technique employing a neural network.

As shown in FIG. 3, the occupant detection unit 21 determines whether the detected person is an adult or a child by performing diagonal determination of the head, arms, and the like of the person based on the image recognition. When a child seat and a person are recognized in a seat, that person may be determined as a child.

The occupant detection unit 21 performs occupant detection based on the results of the image recognition performed on the captured image and the detected values of the load sensors 17. When presence of an occupant or a child seat is recognized in a specific seat based on the captured image, if the detected value of the load sensor 17 of that seat also exceeds a predetermined threshold, the occupant detection unit 21 determines that the occupant or child seat recognized based on the captured image exists in that seat.

In addition, when a door is opened and closed, the occupant detection unit 21 determines whether it was done upon boarding or exiting the vehicle. For example, if the vehicle was traveling a predetermined time before the door was opened and closed, the occupant detection unit 21 determines that the door was opened and closed upon exiting the vehicle, and if the engine of the vehicle C was not driven a predetermined time before the door was opened and closed, it may determine that the door was opened and closed upon boarding the vehicle.

When the occupant detection unit 21 determines that the door was opened and closed upon boarding the vehicle, the occupant detection unit 21 notifies the airbag ECU 14 of the presence or absence of an occupant in each seat detected after the door was closed, as well as whether the person is an adult/child. The airbag ECU 14 configures the settings such that the corresponding airbag 13 would not be activated for a seat having no occupant, the strength of inflation of the corresponding airbag 13 would be reduced for a seat in which a child is seated, and the airbag 13 would be activated with normal strength for the other seats.

In addition, when the occupant detection unit 21 determines that the door was opened and closed upon exiting the vehicle, and it detects an occupant in any of the seats after the door has been closed, the occupant detection unit 21 activates the buzzer 15 to generate an alarm sound. An occupant being detected in a seat after the door has been closed upon exiting the vehicle means that the occupant is likely to have been unintentionally left behind. Therefore, in such cases, an alarm sound is issued by the buzzer 15 to alert those who have already exited the vehicle C and are about to leave it.

The lighting control unit 22 controls turning on/off of the interior light 11 according to the detection value of the door open/close sensor 18 and the detection value of the illuminance sensor 16. Specifically, the lighting control unit 22 turns on the interior light 11 when the door open/close sensor 18 detects that a door has been opened. The lighting control unit 22 turns off the interior light 11 a predetermined time after the opened door is closed (that is, the door open/close sensor 18 detects that the door has been closed). At this time, if the detection value of the illuminance sensor 16 is equal to or smaller than a predetermined threshold, the amount of time from when the door is closed to when the light is turned off (hereinafter, referred to as an “extra illumination time”) is a first amount of time, and if the detection value of the illuminance sensor 16 is equal to or greater than the predetermined threshold, the extra illumination time is a second amount of time that is less than the first amount of time.

In other words, when the inside of the vehicle is bright, such as during the daytime, the extra illumination time is shortened, and when the inside of the vehicle is dark, such as during the nighttime, the extra illumination time is elongated to secure enough integrated amount of light. The term “integrated amount of light” as used in the present embodiment is a value obtained by time-integrating the intensity of illumination of the interior light 11, and particularly it indicates the integrated value of the intensity of illumination in the extra illumination time. In the present embodiment, since the intensity of illumination of the interior light 11 is not changed based on the detection value of the illuminance sensor 16, the integrated amount of light is altered by changing the extra illumination time of the interior light 11.

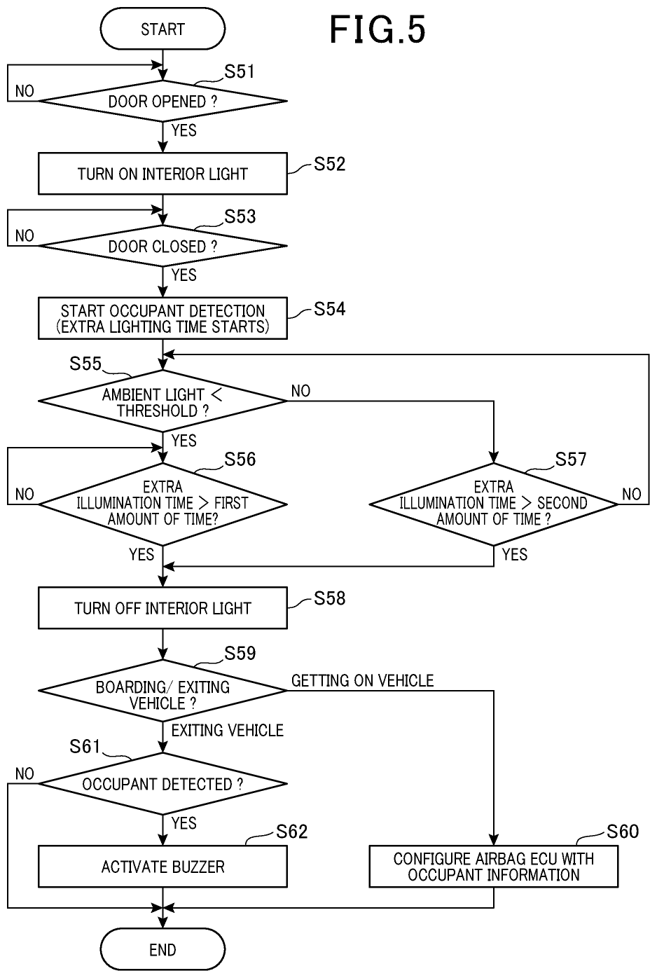

FIG. 5 is a flowchart of a process executed in the occupant detection system and the lighting control system according to the first embodiment of the present disclosure. First, the door open/close sensor 18 monitors the door to detect opening of the door (step S51). When the door open/close sensor 18 detects that the door has been opened (YES in step S51), the lighting control unit 22 turns on the interior light 11 (step S52). Next, the door open/close sensor 18 monitors the door to detect closing of the door (step S53), and when the door open/close sensor 18 detects that the door has been closed (YES in step S53), the occupant detection unit 21 initiates occupant detection and the lighting control unit 22 initiates determination of the extra illumination time (step S54).

The occupant detection process is as described above. The image sensor 20 sequentially outputs captured images generated at predetermined time intervals to the occupant detection unit 21, and the occupant detection unit 21 performs an image recognition process for occupant detection on the captured images sequentially input from the image sensor 20. The occupant detection unit 21 also inputs the detection values of the load sensors 17. The occupant detection unit 21 determines that there is an occupant in a seat that has been judged to have an occupant based on the image recognition, and whose detection value of the load sensor 17 is equal to or greater than a predetermined threshold. In the image recognition, whether the occupant is an adult/child is also determined.

When it is detected that the door has been closed (YES in step S53), the lighting control unit 22 determines whether the detection value of the illuminance sensor 16 (that is, the intensity of the ambient light in the vehicle C) is lower than a predetermined threshold (step S55). When the intensity of the ambient light is lower than the threshold (that is, when it is dark inside the vehicle C) (YES in step S55), the lighting control unit 22 sets the extra illumination time to a relatively large amount of time as the first amount of time. It waits for the first amount of time to elapse (step S56) and when the first amount of time has elapsed (YES in step S56), turns off the interior light 11 (step S58). If the intensity of the ambient light is higher than the threshold (that is, when it is bright inside the vehicle C) (NO in step S55), the lighting control unit 22 sets the extra illumination time to a relatively small amount of time as the second amount of time. It waits for the second time to elapse (step S57) and when the second time has elapsed (YES in step S57), turns off the interior light 11 (step S58).

Once the interior light 11 is turned off, the occupant detection unit 21 determines whether the opening/closing of the door was performed upon boarding or exiting the vehicle (step S59). If it was performed upon boarding the vehicle, the occupant detection unit 21 notifies the airbag ECU 14 of the occupant information of each seat (i.e., presence/absence of an occupant, adult/child) and child seat information (i.e., presence/absence of a child seat) obtained by the occupant detection (step S60). On the other hand, if the opening/closing was performed upon exiting the vehicle and the result of occupant detection indicates presence of an occupant (YES in step S61), the occupant detection unit 21 activates the buzzer 15 (step S62). On the other hand, if the opening/closing was performed upon exiting the vehicle and no occupant is detected (NO in step S61), the process ends.

In the above embodiment, the extra illumination time is selected between two levels, that is, between the first amount of time and the second amount of time that is less that the first amount of time, depending on whether the detection value of the illuminance sensor 16 is larger or smaller than a predetermined threshold. However, the extra illumination time may have three or more levels in accordance with the detection value of the illuminance sensor 16. Alternatively, the extra illumination time may be changed continuously according to the detection value of the illuminance sensor 16. Also, in these cases, the extra illumination time is controlled to be long when the detection value of the illuminance sensor 16 is small. Further, it is also possible that the extra illumination time is constant when the detection value of the illuminance sensor 16 is larger than the predetermined threshold, and when the detection value of the illuminance sensor 16 is smaller than the predetermined threshold, the extra illumination time is changed stepwise or continuously such that it gets longer as the detection value becomes smaller.

Further, in the above-described embodiment, the buzzer 15 is operated when an occupant is detected after the door is closed upon exiting the vehicle. However, alternatively, the buzzer 15 may be operated when it is detected that the door has been closed upon exiting the vehicle and the door has been locked. This prevents the buzzer 15 from being activated in cases where an occupant who has not been unintentionally left behind is detected after the door is temporarily closed, such as when a driver gets out of the driver's seat, closes the door, and then opens the rear seat door from the outside to carry his/her child out of the vehicle. In this case, the door open/close sensor 18 is configured to detect not only the opening/closing of the door but also the locking/unlocking of the door.

As described above, according to the vehicle C of the present embodiment, when a door is closed, detection of occupants and the like is performed based on images captured by the image sensor 20, and based on the detection results of the occupants and the like, setting of the airbag ECU 14 is performed upon boarding the vehicle, and upon exiting the vehicle, the buzzer 15 is operated as necessary to alert the user of an occupant or the like being left behind. When it is dark inside the vehicle C upon capturing images related to the occupant detection, the lighting control unit 22 increases the extra illumination time of the interior light 11 after the door is closed so that the integrated amount of light is increased. This allows the image sensor 10 to obtain more captured images in a state where the passenger compartment is illuminated by the interior light 11. Then, the occupant detection unit 21 can perform image recognition on a larger number of captured images, so that the possibility of detecting an occupant increases if any.

The method of improving the accuracy of occupant detection based on captured images by adjusting the integrated amount of light is not limited to the above-described method. Other embodiments will now be described.

### Second Embodiment

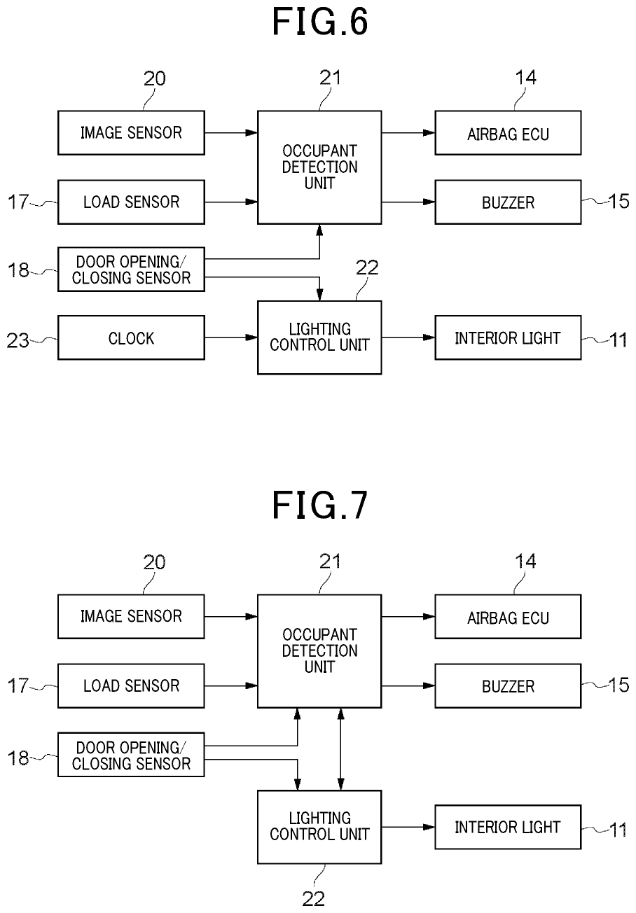

FIG. 6 is a block diagram illustrating the configuration of a vehicle according to the second embodiment of the present disclosure. Components that are similar to those of the first embodiment are denoted by the same reference signs, and description thereof will be omitted as appropriate. The vehicle C according to the present embodiment includes a clock 23 instead of the illuminance sensor 16 according to the first embodiment. The lighting control unit 22 changes the extra illumination time after detecting that the door is closed according to the time of day at that moment. Specifically, when the time of day is from 6:00 pm to 6:00 am the next day, that is, at night, the extra illumination time is set to a relatively large amount of time as the first amount of time, and when it is from 6:00 am to 6:00 pm, that is, in the daytime, the extra illumination time is set to a relatively small amount of time as the second amount of time.

The lighting control unit 22 may variably set the time of day serving as the reference for determining the extra illumination time according to the season. In this case, the time period from the time of sunset to the time of sunrise of the next day may be set as night in which the extra illumination time is set to the first amount of time, and the time period from the time of sunrise to the time of sunset may be set as the daytime in which the extra illumination time is set to the second amount of time. It is also possible to set the time of day for early morning and evening as dim time regions in addition to the nighttime and daytime, and control the extra illumination time in three levels.

According to the present embodiment, since the extra illumination time is determined according to the time of day, similarly to the first embodiment, the extra illumination time is increased when it is dark inside the vehicle C so that the integrated amount of light of the interior light 11 increases. Therefore, the accuracy of detection of occupants and the like by image recognition can be improved.

### Third Embodiment

FIG. 7 is a block diagram illustrating the configuration of a vehicle according to the third embodiment of the present disclosure. Components that are similar to those of the first embodiment are denoted by the same reference signs, and description thereof will be omitted as appropriate. In the vehicle C of the present embodiment, the lighting control unit 22 controls the interior light 11 based on the detection result of occupant detection unit 21. In the first and second embodiments, the lighting control unit 22 controls the illumination by the interior light 11 so that the occupant detection unit 21 has an improved accuracy in the occupant detection based on images captured by the image sensor 20.

In the present embodiment, after the door is closed, the lighting control unit 22 turns on the interior light 11 until the occupant detection using image recognition performed by the occupant detection unit 21 is completed, and turns off the interior light 11 when the occupant detection is completed. As a result, in general, the lighting control unit 22 turns on the interior light 11 for a different extra illumination time every time, and thus the integrated amount of light of the interior light 11 would also change every time in general.

In the present embodiment, the occupant detection unit 21 is capable of recognizing, in addition to people and child seats, the seats (a situation in which there is neither a person nor a child seat) and also other general objects (for example, a bag, a cardboard box, etc.) in the captured image. The occupant detection unit 21 permits the lighting control unit 22 to turn off the interior light 11 when it detects an object and the recognition score (probability) of the object is equal to or greater than a predetermined threshold. The lighting control unit 22 turns off the interior light 11 in response to this permission.

According to the present embodiment, the interior light 11 can be kept on until the occupant detection unit 21 completes image recognition with high reliability, and the occupant detection by image recognition can be performed more reliably.

In the above-described first to third embodiments, the lighting control unit 22 changes the integrated amount of light by adjusting the extra illumination time of the interior light 11, but the method of changing the integrated amount of light is not limited to this. Other embodiments will be described in the following.

### Fourth Embodiment

In the first to third embodiments, the lighting control unit 22 changes the integrated amount of light by adjusting the extra illumination time of the interior light 11. In the present embodiment, the lighting control unit 22 changes the integrated amount of light by adjusting the intensity of illumination of the interior light 11. To this end, the interior light 11 is configured such that its intensity can be changed. This embodiment is applicable to any of the first to third embodiments.

In the case where the present embodiment is applied to the first embodiment, if the detection value of the illuminance sensor 16 is equal to or smaller than a predetermined threshold when the door is closed, the lighting control unit 22 sets the intensity of the interior light 11 to a relatively strong first intensity, and if the detection value of the illuminance sensor 16 is equal to or greater than the predetermined threshold, it sets the intensity of the interior light 11 to a second intensity which is weaker than the first intensity. Thus, when it is dark inside the vehicle C, a brighter environment can be created by increasing the intensity of the interior light 11. Since image recognition is performed on images captured under such illumination, the accuracy of the occupant detection by image recognition can be improved.

In the case where the present embodiment is applied to the second embodiment, if the time of day of when the door is closed corresponds to a preset nighttime, the lighting control unit 22 sets the intensity of the interior light 11 to a relatively strong first intensity, and if the time of day corresponds to a preset daytime, it sets the intensity of the interior light 11 to a second intensity which is weaker than the first intensity.

In the case where the present embodiment is applied to the third embodiment, the lighting control unit 22 gradually increases the intensity of the interior light 11 until the occupant detection unit 21 successfully performs the occupant detection by image recognition.

According to this embodiment, when it is dark inside the vehicle C, the intensity of the illumination of the interior light 11 is increased so as to change the integrated amount of light and obtain captured images that enable occupant detection by image recognition. As a result, occupants can be detected more reliably.

### Fifth Embodiment

In the first to third embodiments, the lighting control unit 22 changes the integrated amount of light by adjusting the extra illumination time of the interior light 11, and in the fourth embodiment, the lighting control unit 22 changes the integrated amount of light by adjusting the intensity of illumination of the interior light 11. In this embodiment, a plurality (specifically, for example, two) of interior lights 11 are installed in the vehicle C so that the plurality of interior lights 11 constitute a lighting unit. This embodiment is applicable to any of the first to third embodiments.

In the case where the present embodiment is applied to the first embodiment, if the detection value of the illuminance sensor 16 is equal to or smaller than a predetermined threshold when the door is closed, the lighting control unit 22 turns on both of the two interior lights 11, and if the detection value of the illuminance sensor 16 is equal to or greater than the predetermined threshold, it turns on only one interior light 11. Thus, when it is dark inside the vehicle C, a brighter environment can be created by increasing the number of interior lights 11. Since image recognition is performed on images captured under such illumination, the accuracy of the occupant detection by image recognition can be improved.

In the case where the present embodiment is applied to the second embodiment, if the time of day of when the door is closed corresponds to a preset nighttime, the lighting control unit 22 turns on two interior lights 11, and if the time of day corresponds to a preset daytime, it turns on only one interior light 11.

In the case where the present embodiment is applied to the third embodiment, the lighting control unit 22 first turns on only one interior light 11, and if the occupant detection unit 21 fails in occupant detection by image recognition, it turns on the other interior light 11. If the occupant detection unit 21 succeeds in occupant detection by image recognition with only one interior light, the interior light 11 that has been on is turned off without turning on the second interior light 11.

According to this embodiment, when it is dark inside the vehicle C, the number of interior lights 11 to be turned on is increased so as to change the integrated amount of light and obtain captured images that enable occupant detection by image recognition. As a result, occupants can be detected more reliably.

As described above, in the first to fifth embodiments, if it is dark inside the vehicle C when occupant detection is to be performed after a door is closed, the lighting control unit 22 controls the interior light(s) 11 so that the integrated amount of light they provide increases. Accordingly, instead of maximizing the extra illumination time or intensity of the interior light 11, or the number of them to be turned on in order that sufficient integrated amount of light is always obtained to enable occupant detection by image recognition even when it is dark inside the vehicle C, the lighting control unit 22 controls the interior light 11 such that the integrated amount of light increases as needed. As a result, it is possible to reduce the discomfort the occupants may feel or the difficulty the driver may have in grasping the situation outside the vehicle by always setting the integrated amount of light large, but still improve the accuracy of occupant detection.

Note that, although the above-described embodiments determine whether the occupant is an adult/child in the occupant detection by image recognition, it is also possible to determine whether the occupant is an elderly person/adult/child, and/or animals (pets) may also be detected. This makes it possible to further notify the user of an elderly person or an animal being left behind using the buzzer 15.

In addition, in the above-described embodiments, the results of the occupant detection performed after a door is closed are used for airbag control upon boarding the vehicle, and used to alert the user of someone or something being left behind upon exiting the vehicle. However, the results of occupant detection may be used for other purposes.

The above embodiments disclose the following configurations.

(Supplementary Note 1)

A lighting control system comprising an interior light 11 as a light source provided inside a vehicle C;

an illuminance sensor 16 for detecting an intensity of ambient light; and

a lighting control unit 22 for determining an extra illumination time of the interior light 11 after a door of the vehicle C is closed, based on a detection value of the illuminance sensor 16.

(Supplementary Note 2)

A lighting control system comprising an interior light 11 as a light source provided inside a vehicle C;

a clock 23; and

a lighting control unit 22 for determining an extra illumination time of the interior light 11 after a door of the vehicle C is closed, based on a time of day of the clock 23.

(Supplementary Note 3)

An airbag control system comprising a camera 10 for capturing an image of an interior of a vehicle C;

an occupant detection unit 21 for detecting an occupant and determining whether the occupant is an adult or a child based on the image captured by the camera 10;

an airbag 13; and

an airbag ECU 14 for controlling the airbag 13 based on a result of the determination of whether the occupant is an adult or a child performed by the occupant detection unit 21.

(Supplementary Note 4)

The airbag control system according to supplementary note 3, characterized in that the occupant detection unit 21 performs the occupant detection after a door of the vehicle C is closed.

What is claimed is:

1. A system for detecting an occupant of a vehicle, comprising:
an imaging unit configured to capture an image of an interior of the vehicle;
a lighting unit configured to illuminate a region in a field of view of the imaging unit;
a lighting control unit configured to automatically control the lighting unit so that an integrated amount of light of the lighting unit changes; and
an occupant detection unit configured to detect an occupant based on the image captured by the imaging unit.

2. The system according to claim 1, wherein the lighting control unit is configured to control the lighting unit such that the integrated amount of light changes according to time of day.

3. The system according to claim 1, wherein the occupant detection system further comprises a measuring unit configured to measure ambient light, and
the lighting control unit is configured to control the lighting unit such that the integrated amount of light changes according to the ambient light measured by the measuring unit.

4. The system according to claim 1, wherein the lighting control unit is configured to control the lighting unit based on an occupant detection result of the occupant detection unit.

5. The system according to claim 1, wherein the lighting control unit is configured to control a duration of illumination of the lighting unit.

6. The system according to claim 1, wherein the lighting control unit is configured to control an intensity of illumination of the lighting unit.

7. The system according to claim 1, wherein the lighting unit comprises a plurality of light sources, and
the lighting control unit is configured to control a number of the light sources to be turned on.

8. The system according to claim 1, further comprising a door detection unit configured to detect opening and closing of a door of the vehicle, and
the lighting control unit is configured to initiate illumination by the lighting unit when the door detection unit detects that the door has been opened.

9. The system according to claim 8, wherein the occupant detection unit is configured to initiate the occupant detection after the door detection unit detects that the door has been closed.

10. The system according to claim 8, wherein the door detection unit is configured to determine whether the opening and closing of the door is performed upon boarding the vehicle or upon exiting the vehicle.

11. The system according to claim 10, further comprising an alarm unit configured to issue an alarm in response to the door detection unit determining that the door has been closed upon exiting the vehicle and then the occupant detection unit detecting an occupant.

12. The system according to claim 1, wherein the occupant detection unit is configured to detect an occupant by recognizing a person based on the image.

13. The system according to claim 12, wherein the occupant detection unit is configured to determine whether the occupant is an adult or a child based on the image.

14. The system according to claim 13, further comprising an airbag, and
an airbag control unit configured to control the airbag based on a result of the determination made by the occupant detection unit as to whether the occupant is an adult or a child.

15. The system according to claim 1, further comprising a load sensor configured to detect a load applied to a seat of the vehicle, and
the occupant detection unit is configured to detect an occupant based not only on the image captured by the imaging unit, but also on the load obtained by the load sensor as well.

16. A system for controlling illumination in a vehicle, comprising:
an imaging unit configured to capture an image of an interior of the vehicle;
a lighting unit configured to illuminate a region in a field of view of the imaging unit;
a door detection unit configured to detect opening and closing of a door of the vehicle; and
a lighting control unit configured to cause the lighting unit to initiate illumination when the door detection unit detects that the door has been opened,
wherein
the lighting control unit is configured to automatically control the lighting unit so that an integrated amount of light of the illumination changes.

17. The system according to claim 16, wherein the lighting control unit is configured to control the lighting unit such that the integrated amount of light after the door detection unit detects that the door has been closed changes.

18. The system according to claim 17, wherein the lighting control unit is configured to control a duration of illumination of the lighting unit.

19. The system according to claim 17, wherein the lighting control unit is configured to control an intensity of illumination of the lighting unit.

20. The system according to claim 17, wherein the lighting unit comprises plurality of light sources, and
the lighting control unit is configured to control a number of the light sources to be turned on.

21. A method for controlling illumination in a vehicle, comprising:
detecting that a door of the vehicle is opened;
initiating illumination in the vehicle using a lighting unit when it is detected that the door is opened;
detecting that the door of the vehicle is closed; and
automatically controlling the lighting unit so that an integrated amount of light of the illumination after the door is detected to be closed changes.
